(19) United States
(12) Patent Application Publication
(10) Pub. No.: US 2022/0030825 A1
(43) Pub. Date: Feb. 3, 2022

(54) Animal Litter Derived From Field Peas

(71) Applicants: Wayne Olson, Fosston, MN (US); Chad Blaser, Fosston, MN (US)

(72) Inventors: Wayne Olson, Fosston, MN (US); Chad Blaser, Fosston, MN (US)

(21) Appl. No.: 17/387,408

(22) Filed: Jul. 28, 2021

Related U.S. Application Data
(60) Provisional application No. 63/057,444, filed on Jul. 28, 2020.

(51) Int. Cl. A01K 1/015

(52) U.S. Cl. CPC A01K 1/0155

(57) ABSTRACT

A composition for animal litter derived from field peas includes dried field peas or some combination of dried field peas, an organic moisture absorbent material, and a filler material. The composition for animal litter provides an organic, biodegradable, and environmentally friendly material for absorbing animal waste and containing odor. A method for making the composition includes harvesting dried field peas, comminuting the dried field peas to a desired particle size, and optionally mixing the dried and sized field pea particles with one or more filler materials to improve various properties of the composition such as moisture absorbency and odor retention. Some filler material examples include oat hulls, grass seed screenings, wheat straw, corn straw, wheat middlings, wood pellets, wood pulp, recycled paper, sawdust, walnuts, barley, or soy pulp.

### CROSS REFERENCE TO RELATED APPLICATIONS

This nonprovisional utility patent application claims priority to and retains the benefit of U.S. Provisional Patent Application No. 63/057,444 filed on Jul. 28, 2020. The above referenced patent application is incorporated in its entirety to provide continuity of disclosure.

### BACKGROUND OF THE INVENTION

The present invention relates to a composition for animal litter and a method for making the same. More specifically, the present invention provides a composition for animal litter that includes dried and sized field pea particles as its primary ingredient, as well as a method for making the same.

Animal litter is utilized as an absorbent, odor-trapping fill material for litter boxes, which are often utilized by cats, rabbits, and other pets. The litter box provides a save environment for the animal to relieve themselves without needing to go into the potentially dangerous outdoor environment. Litter boxes are typically filled with a litter that includes materials which provide absorption capabilities, of both moisture and odors. The litter particles to agglomerate into solid masses or “clump” when in contact with liquid waste such as animal urine. A number of such clumping litters are known. One advantage of such clumping litters is that the solid clumps, which are formed upon wetting of the litter, can be separately removed as discrete entities from the remaining litter. The clumped litter can be discarded by the animal owner, leaving behind a quantity of relatively uncontaminated litter for future use. Other pet owners utilize non-clumping litter as it is usually less expensive to purchase. Some biodegradable litters exist, which often include materials such as pine wood pellets, recycled newspaper, clumping sawdust, Brazilian cassava, corn, wheat, walnuts, barley, soy pulp and dried orange peel. However, these litters are often expensive and may be difficult to obtain. Further, while more friendly to the environment, typical biodegradable litters often lack the desired absorptive and odor shielding properties of their clay counterparts.

The most common type of animal litter is composed of a clay-based material, which is used for its moisture absorbency and sometimes for its clumping properties. Other common materials for non-clumping cat litter include zeolite, diatomite, and sepiolite. One drawback to conventional clay-based cat litter and litter made from similar materials is that it tends to be heavy and difficult to transport. It can also have poor odor control properties. Further, clay-based cat litter cannot be composted or burned in a garbage incinerator, and must be disposed of with landfill-bound garbage. This results in excess waste buildup in landfills. What is needed is a biodegradable, compostable, animal litter that utilizes organic components that are inexpensive and combine to provide desired absorptive and odor retaining properties while still being environmentally friendly.

In light of the animal litter types disclosed in the known art, it is submitted that the present invention substantially diverges in functional and structural elements from the known art and consequently it is clear that there is a need in the art for an improvement to existing animal litter composition. In this regard the present invention substantially fulfills these needs.

### SUMMARY OF THE INVENTION

In view of the foregoing disadvantages inherent in the known types of animal litter compositions in the known art, the present invention provides an animal litter composition derived from field peas, wherein the same can be utilized for producing an animal litter that is environmentally friendly, organic, and biodegradable.

The composition of animal litter derived from field peas generally includes a mixture of field pea particles. The field peas are harvested from the field once they are naturally dried below a particular moisture content percentage. After harvesting, the field peas are comminuted into a desired particle size. The resulting mixture can be utilized as a single component, biodegradable, compostable cat litter, whereby the field peas provide natural abortion and odor retention of liquid and solid animal waste matter. In one embodiment, the composition includes field peas and a filler material. In one embodiment, the composition includes field peas, a filler material, and a supplemental absorptive material. In one embodiment, the composition includes a wood pulp filler material, for example. Other embodiments may include multiple types of filler materials.

One object of the present nvention is to provide a composition for animal litter that utilizes dried field peas as an inexpensive source of absorptive, odor retaining material.

Another object of the present invention is to provide a composition for animal litter that utilizes dried field peas that have been harvested with existing harvesting methods, reducing overall costs.

Yet another object of the present invention is to provide a composition for animal litter that utilizes dried field peas that otherwise would be discarded, thus reducing overall waste.

A further object of the present invention is to provide a composition for animal litter derived from field peas that is biodegradable and compostable, so as to be more environmentally friendly be reducing landfill waste.

Another object of the present invention is to provide a composition for animal litter derived from field peas that includes additional ingredients to enhance the absorptive and odor retaining properties of the present invention.

Still a further object of the present invention is to provide a composition for animal litter that is lighter in weight than traditional clay litters for easier handling and transportation of stored litter.

Yet another object of the present invention is to provide a composition for animal litter that includes field peas as well as additional organic filler materials that can increase the absorption of odor or moisture.

Other objects, features and advantages of the present invention will become apparent from the following detailed description taken in conjunction with the accompanying drawings.

### DETAILED DESCRIPTION OF THE INVENTION

For the purposes of presenting a brief and clear description of the present invention, the preferred embodiment will be discussed as used for providing a biodegradable animal litter composition that is derived from field peas and may contain other ingredients.

Field peas are grown specifically to be dried while still in the field, and then harvested for consumption. The composition of the present invention generally includes field peas that been harvested, cleaned, ground, and sized to a particular particle size. The field peas can additionally be cleaned again in between the grinding and sizing steps. Particles of field peas that are too large may be discarded or reintroduced into the grinding step to reduce the particles to the desired size range. Some embodiments of the present invention include a litter composition derived entirely from, or consisting solely of, the ground, cleaned, and sized field pea particles. The field pea particles include natural moisture absorbing and odor eliminating capabilities. However, some embodiments of the present invention include a litter composition that includes ground, cleaned, and sized field pea particles, as well as additional ingredients for increasing either absorption of moisture or odor or both.

In one embodiment, the dried field peas are ground to a size range that is ideal for providing maximal absorption capabilities by increasing the total surface area, since the number of particles in a given volume increases the lower the size of each particle. In one embodiment, the diameter of the particles ranges between 500 microns and 8 millimeters. This range provides for increased absorption of liquids and odors, while being large and heavy enough to prevent an animal from collecting and tracking litter across the floor. The present invention includes a collection of dried field pea particles that have diameters that differ which provides irregular surface areas for enhanced absorption capability.

In one embodiment, the present invention comprises one hundred percent by weight field pea particles. In other embodiments, the present invention further includes additional filler materials for providing increased absorption of odors or moisture or both. In one embodiment, the present invention includes at least one filler material selected from the group of: oat hulls, grass seed screenings, wheat straw, corn straw, wheat middlings, wood pellets, wood pulp, recycled paper, sawdust, walnuts, barley, or soy pulp. In another embodiment, the present invention includes at least two materials selected from the above group of materials, which can further increase moisture or odor absorption or both. In other embodiments, other natural organic filler materials may be added for their absorptive or odor eliminating properties.

In one embodiment, the present invention includes at least fifty percent by weight field pea particles and at least fifty percent by weight of filler material. In another embodiment, the composition comprises at least fifty percent by weight filler material. In one embodiment, the composition comprises between 40% and 75% by weight field pea particles and between 25% and 60% by weight of the at least one filler material. These particular ranges were found to be ideal for achieving a resulting product that utilizes the maximal amount of field peas for reduced cost and biodegradability with an amount of filler added that improves the overall functioning of the animal litter. In other embodiments, the composition comprises between fifty percent by weight and eighty percent by weight field pea particles. In yet another embodiment, the composition consists of 70% by weight of field pea particles; and 30% by weight of filler material.

It is therefore submitted that the instant invention has been described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation described, and accordingly, all suitable modifications and equivalents may be resorted to, falling within the scope of the invention.

We claim:

1) A composition for animal litter comprising:
a plurality of field pea particles, wherein the plurality of field pea particles are formed from dried and harvested field peas that have been comminuted to a desired particle size.

2) The composition for animal litter of claim 1, wherein the composition comprises one hundred percent by weight field pea particles.

3) The composition for animal litter of claim 1, wherein the field pea particles range in diameter between 500 microns and eight millimeters.

4) The composition for animal litter of claim 1, further comprising at least one filler material.

5) The composition for animal litter of claim 4, wherein the composition comprises between 40% and 75% by weight field pea particles and between 25% and 60% by weight of the at least one filler material.

6) The composition for animal litter of claim 3, wherein the composition comprises at least fifty percent by weight field pea particles.

7) The composition for animal litter of claim 4, wherein the composition comprises at least fifty percent by weight filler material.

8) The composition for animal litter of claim 4, wherein the at least one filler material is selected from the group of: oat hulls, grass seed screenings, wheat straw, corn straw, wheat middlings, wood pellets, wood pulp, recycled paper, sawdust, walnuts, barley, or soy pulp.

9) The composition for animal litter of claim 4, further comprising at least two filler materials selected from the group of: oat hulls, grass seed screenings, wheat straw, corn straw, wheat middlings, wood pellets, wood pulp, recycled paper, sawdust, walnuts, barley, or soy pulp.

10) The composition for animal litter of claim 1, wherein the composition comprises between fifty percent by weight and eighty percent by weight field pea particles.

11) A composition for animalitter consisting of:
a plurality of field pea particles, wherein the plurality of field pea particles are formed from dried and harvested field peas that have been comminuted to a desired particle size.

12) A composition for animal litter consisting of:
70% by weight of field pea particles; and
30% by weight of filler material selected from the group of: oat hulls, grass seed screenings, wheat straw, corn straw, wheat middlings, wood pellets, wood pulp, recycled paper, sawdust, walnuts, barley, or soy pulp.
